(19) United States
(12) Patent Application Publication
(10) Pub. No.: US 2026/0255308 A1
(43) Pub. Date: Aug. 27, 2026

(54) SHARING SYSTEM AND METHOD FOR CHILD DEVICE THAT MAKES WIRELESS COMMUNICATION CONNECTION TO PARENT DEVICE

(71) Applicant: MAXELL, LTD., Kyoto (JP)

(72) Inventors: Kazuyuki TAKIZAWA, Kyoto (JP); Hitoshi AKIYAMA, Kyoto (JP); Mayumi NAKADE, Kyoto (JP); Shigeyuki ITOU, Kyoto (JP)

(21) Appl. No.: 19/160,087

(22) PCT Filed: Feb. 28, 2023
(86) PCT No.: PCT/JP2023/007180

§ 371 Date: Aug. 27, 2025

(51) Int. Cl. H04W 64/00; H04W 76/10; H04W 76/30

(52) U.S. Cl. CPC H04W 64/00; H04W 76/10; H04W 76/30

(57) ABSTRACT

A sharing system for a child device that makes a wireless communication connection to a parent device includes a parent device, a child device, and a base station (BS). The BS registers the sharing state of the child device and measures the relative location of both the child device and the parent device within a BS management area. When both devices are outside the area, the BS sends a connection request to the parent device, updates the child device status to “taken-out,” and sets the parent as its connection target. Upon the child device's return, the BS sends a disconnection request to the parent device, resets the child device status to “stored,” and removes the parent device as its connection target.

### TECHNICAL FIELD

The present invention relates to a sharing system and method for a child device that makes a wireless communication connection to a parent device.

### BACKGROUND ART

As a preventive measure to avoid misplacing valuables or having them stolen, a loss-prevention tag (hereinafter referred to as a tag) with built-in communication functions such as short-range wireless communication is available. Registering a tag with a mobile terminal such as a smartphone and making a wireless connection enables the mobile terminal to identify the location of the tag and notify the mobile terminal side when the tag is further away than a specified distance. Attaching this tag to a key, a wallet, or the like allows it to be immediately located.

Some of the tags allow a single tag to be shared by more than one person. If the user permits a shareable tag to be shared and registers other mobile terminals for sharing, the tag can be wirelessly connected from any mobile terminal, allowing a single tag to be used by more than one mobile terminal.

As technology related to such a shareable tag, the following authentication method is disclosed in Patent Literature 1: “An authentication system includes: a child device and a parent device that perform short-range wireless communication with each other; and a management server that communicates with the parent device via a network. The authentication system performs: a step of transmitting a public key of the child device and a parent device IDx to the management server; a step of determining whether a parent device already registered with the child device exists or not using the public key of the child device as an identification tag; and a step of transmitting, if a parent device ID already registered exists, a notification of the child device requesting an SSP process to a new parent device to a parent device identified by the parent device IDx already registered (excerpt from the abstract).”

### CITATION LIST

### Patent Literature

Patent Literature 1: Japanese Unexamined Patent Application Publication No. 2017-84297

### SUMMARY OF INVENTION

### Technical Problem

Generally, the tags cannot be shared for privacy reasons. To share a common tag with more than one person, the connection to a mobile terminal of a person who has been using it needs to be disconnected and the connection to a mobile terminal of a person who will use it next needs to be made each time a different person takes it out, which is very cumbersome.

In addition, there is a problem that privacy is not protected since a shareable tag allows other mobile terminals that are registered for sharing to identify the location of the tag and the terminal that the tag is connected to. In the case of sharing a child device that makes a wireless connection to a mobile terminal with others, privacy may also be violated as the location of the child device is identifiable, and therefore, the problem described above is not limited to tags.

The present invention was made in view of the problems described above, and its purpose is to share a child device that makes a wireless connection to a parent device with others while protecting privacy.

### Solution to Problem

To achieve the purpose described above, the present invention is provided with the configuration described in the claims. To provide one example, the present invention is a sharing system for a child device that makes a wireless communication connection to a parent device including: a child device; a parent device that makes a wireless connection to the child device using a short-range wireless communication interface; and a base station, in which the base station includes: a mobile communication interface that communicates with the parent device; a short-range wireless communication interface that performs short-range wireless communication with each of the parent device and the child device; a location measuring sensor that measures a child device location, which is a relative location of the child device to the base station, and a parent device location, which is a relative location of the parent device to the base station in a base station management area that consists of a real space including an existence location of the base station; a memory that stores a device list; and a first processor that updates the device list. The device list is registered with status information that indicates the parent device location, the child device location and a sharing state of the child device. The parent device includes a mobile communication interface and a parent device short-range wireless communication interface that performs short-range wireless communication with the child device. The child device includes a child device short-range wireless communication interface that performs short-range wireless communication with each of the base station and the parent device. The first processor, when determining that the child device is inside the base station management area based on the child device location, updates the status information of the child device in the device list to a stored state, makes a wireless connection to the child device using the short-range wireless communication interface of the base station, and when determining that the parent device has been taken out with the child device based on the child device location and the parent device location, disconnects the wireless connection of the child device to the base station, transmits a child device connection request signal that requests a wireless connection to the child device to the parent device, updates status of the child device in the device list to a taken-out state and updates a wireless connection target of the child device to the parent device, with the parent device making a wireless connection to the child device using the parent device short-range wireless communication interface in response to the child device connection request signal, in which the first processor, when determining that the child device has returned to inside the base station management area based on the child device location, transmits a child device disconnection request signal that requests disconnection of the wireless connection to the child device to the parent device, updates the status information of the child device in the device list to the stored state and updates the wireless connection target of the child device from the parent device to the base station, with the parent device disconnecting the wireless connection to the child device using the parent device short-range wireless communication interface in response to the child device disconnection request signal, and the base station making a wireless connection to the child device using the short-range wireless communication interface.

### Advantageous Effects of Invention

According to the present invention, the child device that makes a wireless connection to the parent device can be shared with others while protecting privacy. Purposes, configurations and advantageous effects other than those described above will be disclosed in the following embodiments.

### BRIEF DESCRIPTION OF DRAWINGS

FIG. 1 is a diagram illustrating a configuration of a sharing system for a loss prevention tag according to embodiments of the present invention.

FIG. 2 is a diagram illustrating an example of a hardware configuration of a BS.

FIG. 3 is a diagram illustrating an example of a hardware configuration of the tag.

FIG. 4 is a diagram illustrating an example of a hardware configuration of a mobile terminal.

FIG. 5A is a schematic diagram illustrating a state in which the tag and the mobile terminal have been taken out of a BS management area together from the state shown in FIG. 1.

FIG. 5B is a schematic diagram illustrating a state in which the tag alone has been taken out of the BS management area from the state shown in FIG. 1.

FIG. 6 is a flowchart illustrating a process for sharing the loss-prevention tag according to a first embodiment.

FIG. 7 is a flowchart illustrating the details of a process of device registration.

FIG. 8A is a table showing an example of a device list that is prepared by the BS.

FIG. 8B is a table showing an example of the device list that is prepared by the BS.

FIG. 8C is a table showing an example of the device list that is prepared by the BS.

FIG. 9 is a diagram illustrating a state in which the tag has been taken out of the BS management area from the state shown in FIG. 1 by a different user.

FIG. 10 is a table showing an example of the device list when the state is transitioned from the state shown in FIG. 1 to the state shown in FIG. 9.

FIG. 11 is a diagram illustrating a configuration of a sharing system for a loss-prevention tag according to a second embodiment.

FIG. 12 is a flowchart illustrating a process for sharing the loss prevention tag according to the second embodiment.

### DESCRIPTION OF EMBODIMENTS

The following is a description of embodiments of a sharing system and method for a child device that makes a wireless communication connection to a parent device according to the present invention with reference to the drawings. Throughout all the drawings, the same invention is indicated by the same reference sign, and duplicate explanations are omitted.

The present invention can provide a sharing system and method for a child device that makes a wireless communication connection to a parent device with consideration for individual privacy and is expected to contribute to the improvement of technologies for labor-intensive industries, thus contributing to the Sustainable Development Goals (SDGs) 8.2 (achieve higher levels of economic productivity through diversification, technological upgrading and innovation, including through a focus on high-value added, for goods and services, and labour-intensive sectors) proposed by the United Nations.

In the following description, embodiments of the sharing system and method for the child device that makes a wireless communication connection to the parent device according to the present invention will be described using an example of the application of a sharing system for a loss-prevention tag. Thus, in the following description, a mobile terminal corresponds to the parent device and the tag corresponds to the child device.

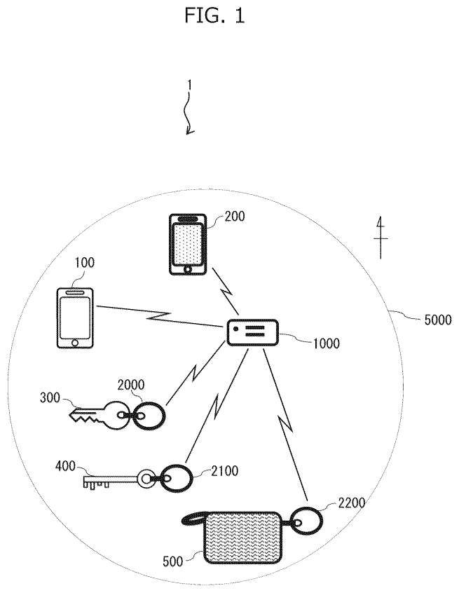

FIG. 1 is a diagram illustrating a configuration of the sharing system for the loss-prevention tag according to the embodiments of the present invention.

The sharing system for the loss-prevention tag 1 shown in FIG. 1 is configured to include a base station (hereinafter referred to as “BS”) 1000 that registers mobile terminals 100 and 200, and a sharing state of tags 2000, 2100 and 2200. The tags 2000, 2100 and 2200 are attached to a key 300, a key 400 and a bag 500, respectively.

Prior to starting a tag sharing operation by the BS 1000, the mobile terminals 100 and 200, and the tags 2000, 2100 and 2200 are registered with the BS 1000.

A partial area of a real space including an existence location of the BS 1000 in which relative locations of the mobile terminals 100 and 200, and the tags 2000, 2100 and 2200 are managed is referred to as a base station management area (hereinafter referred to as the “BS management area”) 5000. The BS management area 5000 is within a distance at which a wireless communication method used for relative location measurement can provide full location measurement of the mobile terminal 100 and the tag 2000. The coverage of the BS management area 5000 varies depending on the operating environment and the radio wave intensity of the wireless communication method used for the relative location measurement. Although depending on the performance of the wireless communication method used for the relative location measurement, the communication available area may be wider than the BS management area 5000 that has been set, it is to be understood that in such a case, even if the BS 1000 can measure relative locations, the location may exist outside the BS management area 5000 depending on the measurement result. The coverage of the BS management area 5000 may be arbitrarily changed by a user. In the case where all wireless communication methods used for relative location measurement of the mobile terminal 100 and the tag 2000 to the BS 1000 have the same performance, the communication coverage of the wireless communication methods may be set to the BS management area 5000. In the embodiments of the present invention, as an example, the BS management area 5000 is set as a circular area with a radius of 7 m centered on the BS 1000.

In the present embodiments, the BS 1000 uses ultra-wideband (UWB) wireless communication to detect the relative locations of the mobile terminals 100 and 200, and the tags 2000, 2100 and 2200. Thus, an ultra-wideband wireless communication interface (UWB interface) installed in the BS 1000 serves as a location measuring sensor. Using the UWB interface, the distance and the direction to the mobile terminals 100 and 200, and the tags 2000, 2100 and 2200 with respect to the BS 1000 can be detected based on the time of arrival of radio waves and the direction of arrival of received waves, providing the relative locations as a result of detection. The relative locations here mean that, unlike absolute locations expressed in the so-called world coordinate system for uniquely identifying a single point in the real space, only locations with respect to the BS are defined.

The BS 1000 measures one or both of the location and the distance to the mobile terminals 100 and 200, and the tags 2000, 2100 and 2200 as the relative locations. The relative locations of the mobile terminals 100 and 200 correspond to parent device locations, and the relative locations of the tags 2000, 2100 and 2200 correspond to child device locations.

The BS 1000, when determining that the locations of both of the mobile terminal 100 and the tag 2000 have been out of the BS management area 5000, transmits a tag connection request signal, which corresponds to a child device connection request signal, to the mobile terminal 100 to make a wireless connection to the mobile terminal 100 and the tag 2000 that are out of the BS management area 5000 using a short-range wireless communication interface. The mobile terminal 100 that has received the tag connection request signal automatically makes a wireless connection to the tag 2000 that has been out of the BS management area 5000 together. A Bluetooth (registered trademark) interface, for example, is used for this short-range wireless communication, but other communication methods may also be used.

The BS 1000 is provided with a device list in which device information on the mobile terminal 100 and the tag 2000 that have been registered, connection target information of the short-range wireless communication interface, relative location information and other information are recorded. For the connection target information and the relative location information that constantly change, the device list is updated each time measurement is performed.

The device list may be managed by something other than the BS 1000. For example, a management server may be provided on a PC or a network to update the device list. A PC, the mobile terminal 100 or 200, or other device may be connected to the BS 1000 to have them perform the registration or setting-change operations for the mobile terminals 100 and 200, and the tags 2000, 2100 and 2200.

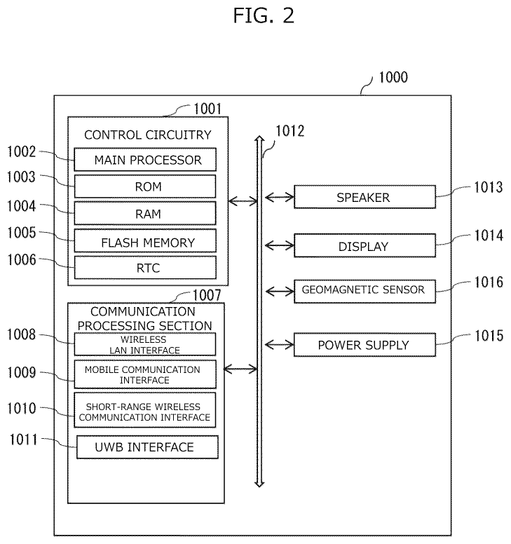

FIG. 2 is a diagram illustrating an example of a hardware configuration of the BS 1000.

The BS 1000 is configured to include a control circuitry 1001, a data bus 1012, a communication processing section 1007, a speaker 1013, a display 1014, a power supply 1015, a geomagnetic sensor 1016, and the like.

The control circuitry 1001 is configured to include a main processor 1002, which corresponds to a first processor, a read-only memory (ROM) 1003, a random access memory (RAM) 1004, a flash memory 1005, a real-time clock (RTC) 1006, and the like.

The ROM 1003 stores an operation program for the BS 1000.

The RAM 1004 is a memory that serves as a working area to load the operation program.

The flash memory 1005 stores the device list.

The RTC 1006 provides the date and time when the locations and distances of the mobile terminals 100 and 200, and the tags 2000, 2100 and 2200 are measured.

The communication processing section 1007 is configured to include a wireless LAN interface 1008, a mobile communication interface 1009, a short-range wireless communication interface 1010 and a UWB interface 1011. The short-range wireless communication interface 1010 is, for example, a Bluetooth (registered trademark) communication interface (hereinafter referred to as “BT interface”), or the like. When the tags 2000, 2100 and 2200 are inside the BS management area 5000, the tags 2000, 2100 and 2200 make a wireless communication connection to the BS 1000 via the BT interface, although the wireless communication connections may be made via a communication method other than the BT interface.

The mobile communication interface 1009 is an interface that can access a mobile phone communication network such as 4G, 5G or LTE.

Based on information from the communication processing section 1007, or the like and the process of registering the mobile terminals 100 and 200, and the tags 2000, 2100 and 2200, the control circuitry 1001 performs the measurement of the relative locations and distances of the mobile terminals 100 and 200, and the tags 2000, 2100 and 2200, the calculation of mutual distances between the mobile terminals 100 and 200, and the tags 2000, 2100 and 2200 and their movement directions, the determination of whether a device has been out of the BS management area 5000 or not, the instruction of transmitting the tag connection request signal, which corresponds to the child device connection request signal, a tag disconnection request signal, which corresponds to a child device disconnection request signal, and the triggering of an alarm of the speaker 1013, and the like.

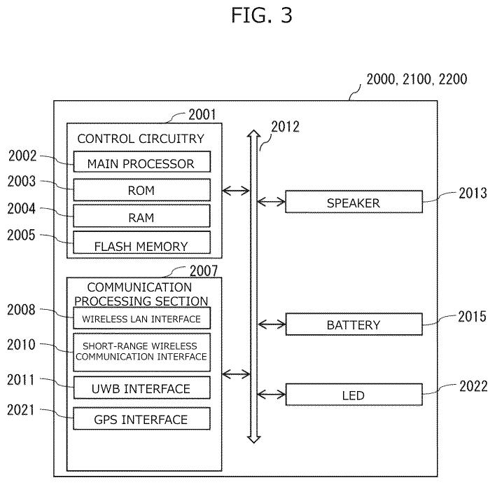

FIG. 3 is a diagram illustrating an example of a hardware configuration of the tags 2000, 2100 and 2200.

Each of the tags 2000, 2100 and 2200 is configured to include a control circuitry 2001, a data bus 2012, a communication processing section 2007, a speaker 2013, a battery 2015, an LED 2022, and the like.

The control circuitry 2001 is configured to include a main processor 2002, a ROM 2003, a RAM 2004 and a flash memory 2005.

The ROM 2003 stores an operation program for the tags 2000, 2100 and 2200.

The RAM 2004 is a memory that serves as a working area to load the operation program.

The flash memory 2005 stores the device information on the tags 2000, 2100 and 2200, and the like.

The communication processing section 2007 is configured to include a wireless LAN interface 2008, a short-range wireless communication interface 2010, which corresponds to a child device short-range wireless communication interface, a UWB interface 2011 and a GPS interface 2021.

The control circuitry 2001 performs the process of making a short-range wireless communication connection to the BS 1000, or the mobile terminal 100 or 200 using the short-range wireless communication interface 2010 in response to a connection request from the BS 1000, or the mobile terminal 100 or 200.

The LED 2022 indicates a connection state, remaining battery capacity, and the like of each of the tags 2000, 2100 and 2200.

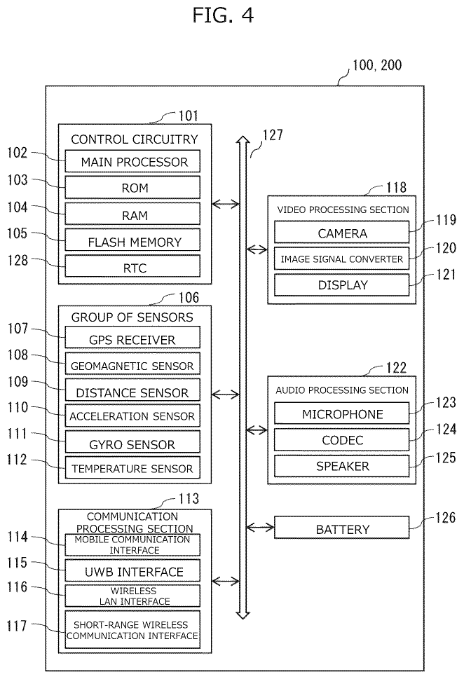

FIG. 4 is a diagram illustrating an example of a hardware configuration of the mobile terminals 100 and 200.

Each of the mobile terminals 100 and 200 is configured to include a control circuitry 101, a data bus 127, a group of sensors 106, a communication processing section 113, a video processing section 118, an audio processing section 122 and a battery 126.

The control circuitry 101 is configured to include a main processor 102, which corresponds to a second processor, a ROM 103, a RAM 104, a flash memory 105 and an RTC 128.

The ROM 103 stores an operation program for the mobile terminals 100 and 200.

The RAM 104 is a memory that serves as a working area to load the operation program.

The flash memory 105 stores applications and application data for the mobile terminals 100 and 200, and various kinds of setting information for the mobile terminals 100 and 200.

The RTC 128 provides the date and time when various kinds of applications operate, and the date and time when the various kinds of setting information are stored.

The group of sensors 106 is configured to include a GPS receiver 107, a geomagnetic sensor 108, a distance sensor 109, an acceleration sensor 110, a gyro sensor 111 and a temperature sensor 112.

The video processing section 118 is configured to include a camera 119, an image signal converter 120 and a display 121.

The camera 119 captures still images and movies.

The image signal converter 120 performs the process of signal conversion (for example, A/D conversion process or D/A conversion process) of an image signal that has been captured, and the like, stores the resulting signal in the flash memory 105 and displays it on the display 121.

The audio processing section 122 is configured to include a microphone 123, a codec 124 and a speaker 125.

The microphone 123 is used for audio communication or audio input, and the codec 124 performs the audio signal processing.

The communication processing section 113 is configured to include a mobile communication interface 114, a UWB interface 115, a wireless LAN interface 116 and a short-range wireless communication interface 117, which corresponds to a parent device short-range wireless communication interface.

The control circuitry 101 performs the operation control of the mobile terminals 100 and 200 using the operation program for the mobile terminals 100 and 200 that is stored in the ROM 103, and the interlinked operation with the video processing section 118, the group of sensors 106, the communication processing section 113 and the audio processing section 122 according to the application stored in the flash memory 105.

### <First Embodiment>

A first embodiment is an embodiment in which the BS 1000 uses UWB to measure the relative locations of the mobile terminals 100 and 200, and the tags 2000, 2100 and 2200.

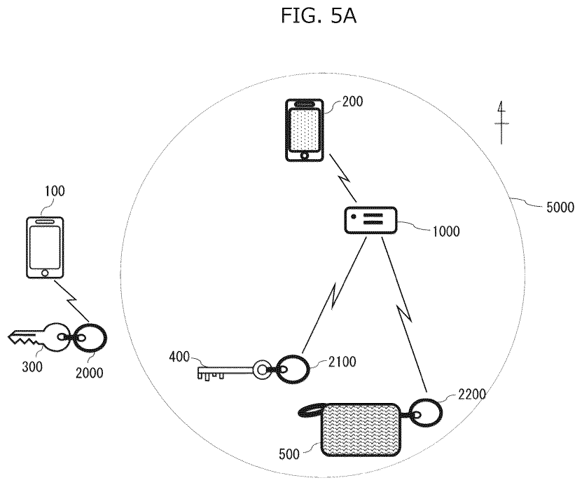

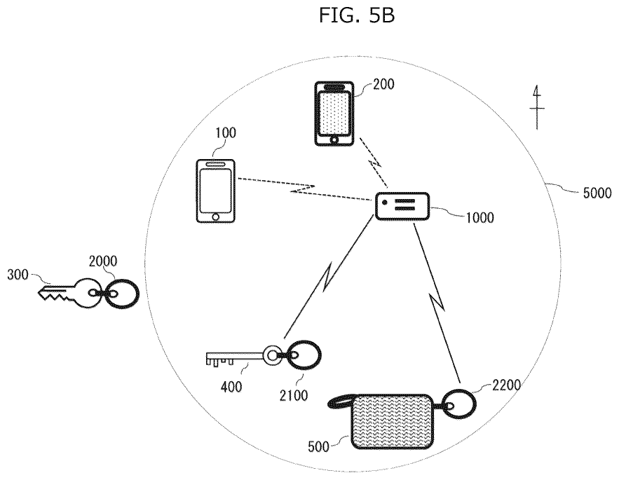

States used in the description below are described with reference to FIG. 1, FIG. 5A and FIG. 5B. FIG. 5A is a schematic diagram illustrating a state in which the tag 2000 and the mobile terminal 100 have been taken out of the BS management area 5000 together from the state shown in FIG. 1. FIG. 5B is a schematic diagram illustrating a state in which the tag 2000 alone has been taken out of the BS management area 5000 from the state shown in FIG. 1.

In the initial state shown in FIG. 1, the key 300 with the tag 2000 attached and the mobile terminal 100 are inside the BS management area 5000. When going out, the user carries the mobile terminal 100 and the key 300 as shown in FIG. 5A.

This state is described as a normally taken-out state. The “normally taken-out state” here means that the tag 2000 and the mobile terminal 100 are taken out together. In contrast, as shown in FIG. 5B, if the tag 2000 alone has been taken out, in other words, if the mobile terminal 100 and the tag 2000 have not been taken out together, the user who keeps the tag 2000 outside the BS management area 5000 will be unknown, and the status shall be the abnormally taken-out state.

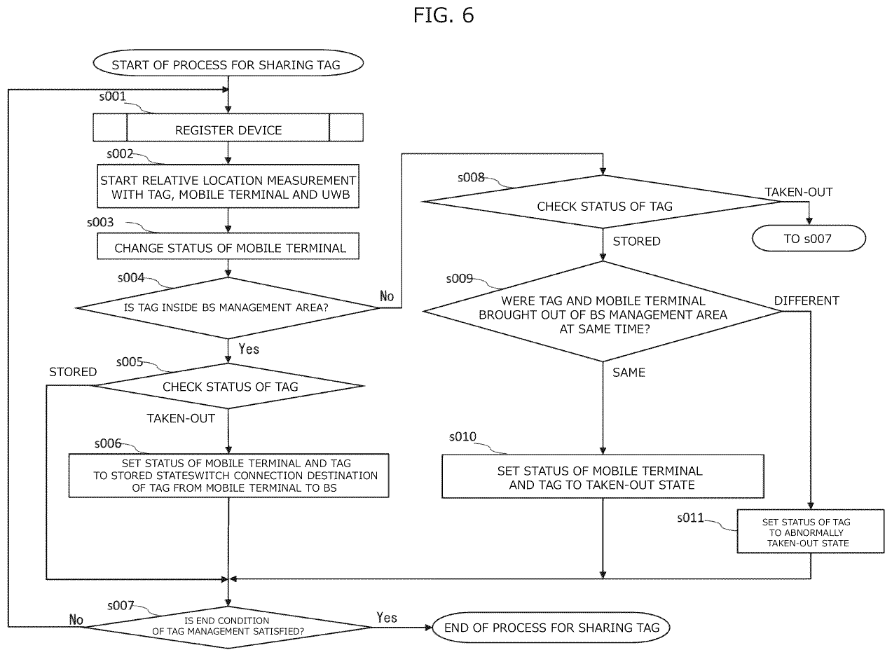

The first embodiment is described below with reference to FIG. 6. FIG. 6 is a flowchart illustrating a process for sharing the loss-prevention tag according to the first embodiment. Although FIG. 1, FIG. 5A and FIG. 5B illustrate the mobile terminals 100 and 200, and the tags 2000, 2100 and 2200, the operation of taking the mobile terminal 100 and the tag 2000 out of the BS management area 5000 and bringing them back is described for convenience of explanation, thus the mobile terminal 100 and the tag 2000 are discussed while the other devices, in other words, the mobile terminal 200 and the tags 2100 and 2200, are not discussed. Note, however, that the description for the mobile terminal 100 and the tag 2000 also applies to the mobile terminal 200 and the tags 2100 and 2200.

### (Process of Device Registration)

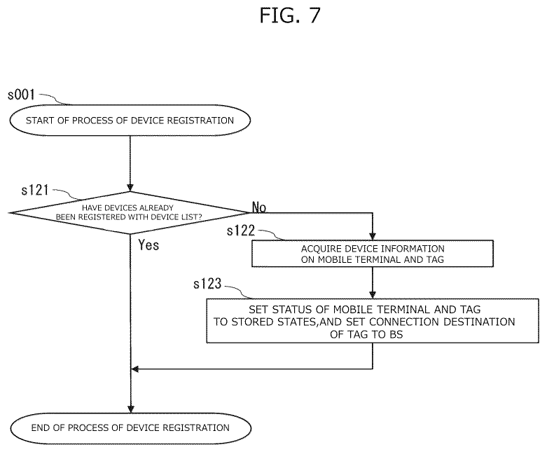

First, the user registers the tag 2000 and the mobile terminal 100 that are to be managed with the BS 1000 (s001). FIG. 7 is a flowchart illustrating the details of the process of device registration.

The BS 1000 checks whether devices to be registered have already been registered with the device list or not (s121). If the devices have already been registered (s121:

Yes), the device registration ends without performing the process of registration.

If any device has not been registered (s121: No), the device information will be registered for each of the mobile terminal 100 and the tag 2000, which are the devices to be registered (s122). The BS 1000 then makes a wireless connection to the tag 2000 using the short-range wireless communication interface 1010, sets the status of the mobile terminal 100 and the tag 2000 to a stored state, sets a connection target of the tag 2000 to the BS 1000 and ends the process of device registration (s123). Since the process of device registration in s001 is performed inside the BS management area 5000, the initial status, in other words, the status of the tag 2000 immediately after the process of device registration, is always “stored.”

The device information includes “type,” “name,” and the like for each of the mobile terminal 100 and the tag 2000, as well as “phone number” for the mobile terminal 100. After the process of device registration ends, the flow proceeds to a process of managing the location of the tag 2000.

### (Process of Managing Location of Tag)

s002 and onward in FIG. 6 correspond to the process of managing the location of the tag 2000. The BS 1000 starts the relative location measurement of the tag 2000 and the mobile terminal 100 (s002). The BS 1000 uses the UWB interface 1011 to measure the relative locations of the mobile terminal 100 and the tag 2000 with respect to the BS 1000. The relative location includes at least one of relative distance and relative direction, preferably both. The relative location measurement by the BS 1000 is periodically performed for all of the mobile terminals 100 and 200, and the tags 2000, 2100 and 2200 that have been registered.

The BS 1000 changes the status of the mobile terminal 100 based on the result of the relative location measurement of the mobile terminal 100 in s002 (s003). The status is changed each time the relative location measurement is performed. As described above, the BS management area 5000 is set as a circular area with a radius of 7 m centered on the BS 1000. When the distance between the BS 1000 and the mobile terminal 100 is less than 7 m, the main processor 1002 determines that the mobile terminal 100 is inside the BS management area 5000 and changes the status of the mobile terminal 100 to “stored.” When the distance to the BS 1000 increases as the mobile terminal 100 is taken out, so that the relative location of the mobile terminal 100 cannot be measured, or the distance is 7 m or more, the mobile terminal 100 is determined to be out of the BS management area 5000, and the status of the mobile terminal 100 is changed to “taken-out.” The relative location information of the mobile terminal 100 and the result of determining whether it is inside the BS management area 5000 or not may be notified to the mobile terminal 100. Since the mobile terminal 100 alone may also be taken out, its status is managed separately from that of the tag 2000.

In step s004, the location of the tag 2000 is determined based on the result of the relative location measurement of the tag 2000 in s002. When the distance between the BS 1000 and the tag 2000 is less than 7 m, the main processor 1002 determines that the tag 2000 is inside the BS management area 5000 (s004: Yes).

The BS 1000 then checks the status of the tag 2000 (s005). If the status of the tag 2000 is the “stored” state (s005: stored), it is determined that the tag 2000 is still standing by inside the BS management area 5000, leaving the status unchanged, and the flow proceeds to step s007.

If the status of the tag 2000 is the “taken-out” state (s005: taken-out), it means that the tag 2000 has been brought back to the BS management area 5000, thus the BS 1000 performs a tag return process (s006).

In step s006, the BS 1000 transmits the tag disconnection request signal to the mobile terminal 100 that has been brought back to the BS management area 5000 together. After the mobile terminal 100 disconnects the wireless connection to the tag 2000 using the short-range wireless communication interface 117, the BS 1000, upon receiving the tag disconnection completion signal transmitted from the mobile terminal 100, makes a wireless connection to the tag 2000, switches a wireless connection target of the tag 2000 in the device list from the mobile terminal 100 to the BS 1000, erases the wireless connection target of the mobile terminal 100 and changes the status of the mobile terminal 100 and the tag 2000 to the “stored” state. Then, the flow proceeds to step s007.

If an end condition of a process for sharing the tags is satisfied (s007: Yes), the process ends. If it is not satisfied (s007: No), the flow returns to s001. When the end condition of the process for sharing the tag is satisfied, it means, for example, that the main power of the BS 1000 is turned off, the battery of the tag 2000 runs out, the tag 2000 is erases from the device list, or any other condition in which the management of the tag 2000 cannot be continued. Note, however, that turning off the main power of the BS 1000 does not delete the device list, thus allowing devices that have been registered to be immediately available for the process for sharing when the main power is turned on again.

Conversely, when the BS 1000 cannot measure the relative location to the tag 2000, or the distance between the BS 1000 and the tag 2000 is 7 m or more in step s004, the main processor 1002 determines that the tag 2000 is not inside the BS management area 5000 (s004: No) and checks the status of the tag (s008).

If the status of the tag 2000 is “taken-out” in step s008 (s008: taken-out), it is determined that the tag 2000 is a tag that has already properly been taken out, and the flow proceeds to step s007 without changing the status.

If the status of the tag 2000 is “stored” in step s008 (s008: stored), and the tag 2000 and the mobile terminal 100 move out of the BS management area 5000 at the same time in this state (s009: same), the BS 1000 determines that this is a normal take-out. The BS 1000 disconnects the wireless connection to the tag using the short-range wireless communication interface 1010, transmits the tag connection request signal to the mobile terminal 100, changes the status of the mobile terminal 100 and the tag 2000 in the device list to “taken-out, ” changes the wireless connection target of the tag 2000 from the BS 1000 to the mobile terminal 100 and changes the wireless connection target of the mobile terminal 100 to the tag 2000 (s010). The mobile terminal 100, upon receiving the tag connection request signal, makes a wireless connection to the tag 2000 using the short-range wireless communication interface 117 and manages the tag 2000 that is being taken out. Then, the flow proceeds to step s007.

If the status of the tag 2000 is identified as “stored” in step s008 (s008: stored), when the tag 2000 and the mobile terminal 100 move out of the BS management area 5000 at different times (s009: different), the BS 1000 determines that the tag 2000 is in a situation in which it has abnormally been taken out. At this time, the status of the tag 2000 in the device list is set to “abnormally taken-out” (s011), the mobile terminal 100 receives an alarm notification, and the BS 1000 itself also triggers an alarm.

Then, the flow proceeds to step s007.

Another method to improve the accuracy of the determination in s009 performed by the main processor 1002 of the BS 1000, in other words, the determination of whether the tag 2000 and the mobile terminal 100 have moved out of the BS management area 5000 at the same time or not, is a method in which the main processor 1002 of the BS 1000 periodically measures the relative location of each of the mobile terminal 100 and the tag 2000 and calculates the movement directions of the mobile terminal 100 and the tag 2000 as well as the distance between them based on the changes in their respective relative locations. If the mobile terminal 100 and the tag 2000 are within a set distance and moving in the same direction, it may be determined that the user carries them together while moving. The distance for determining whether the user carries them together while moving or not depends on how the user is using them, thus it can be arbitrarily changed by the user.

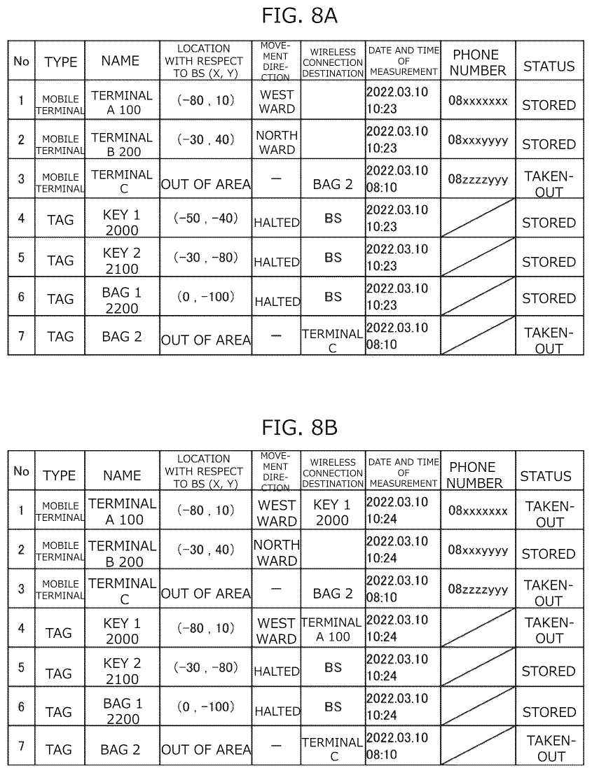

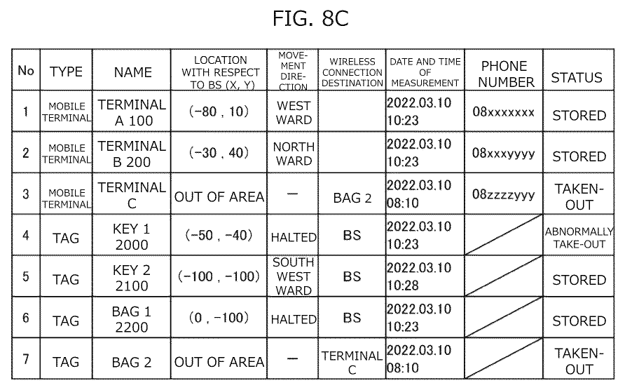

The device list is described with reference to FIG. 8A through FIG. 8C. The device list needs to include different items depending on the embodiment. FIG. 8A through FIG. 8C are tables showing examples of the device list that is prepared by the BS 1000.

FIG. 8A shows an example in which the relative location measured with UWB (expressed as “location with respect to BS (X, Y) ” in the table), the “movement direction” calculated using an amount of displacement of the relative location and data obtained by the geomagnetic sensor 1016 of the BS 1000, the “wireless connection target,” which is the connection target of the short-range wireless communication interface 1010 of the BS 1000, a “date and time of measurement” obtained by the RTC 1006 and “status”, is written into the device information including “type” and “name” of the mobile terminals 100 and 200, and the tags 2000, 2100 and 2200 that are registered with the BS 1000, and “phone number” of the mobile terminals 100 and 200.

FIG. 8B is an example of the device list when the status is transitioned from the state shown in FIG. 1 to the state shown in FIG. 5A. FIG. 8B is an example of updating the connection target and status with respect to the tag 2000 and the mobile terminal 100 that have normally been out of the BS management area 5000 in the device list of FIG. 8A.

In FIG. 8B, the status of the mobile terminal 100 and the tag 2000 is updated to “taken-out, ” the wireless connection target of the mobile terminal 100 using the short-range wireless communication interface 117 is updated to the tag 2000, and the wireless connection target of the tag 2000 is updated from the BS 1000 to the mobile terminal 100.

FIG. 8C is an example of the device list when the status is transitioned from the state shown in FIG. 1 to the state shown in FIG. 5B. FIG. 8C is an example of updating the connection target and status when only the tag 2000 has been out of the BS management area 5000 in the device list of FIG. 8A.

The BS 1000, when determining that the tag 2000 alone has been out of the BS management area 5000, determines that the tag 2000 has abnormally been taken out and updates the status to the “abnormally taken-out” state.

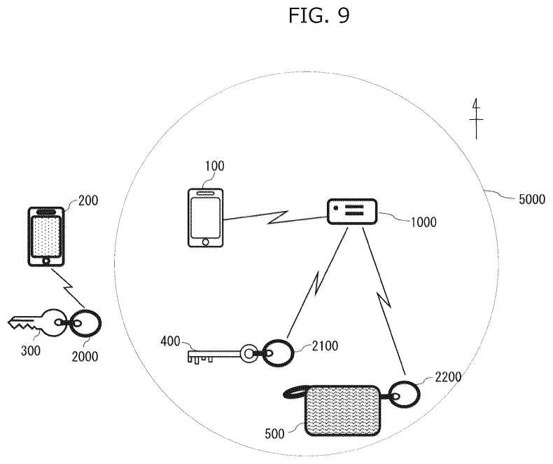

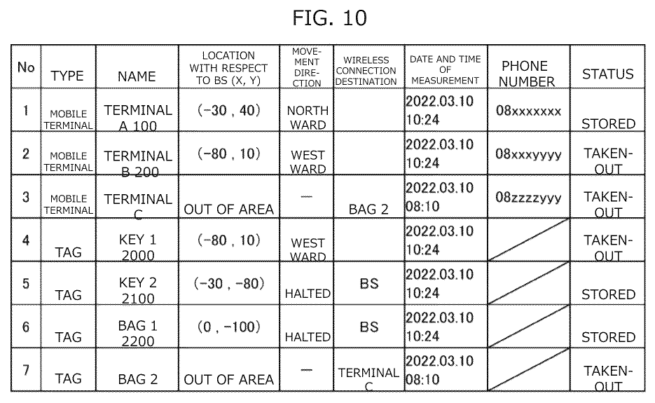

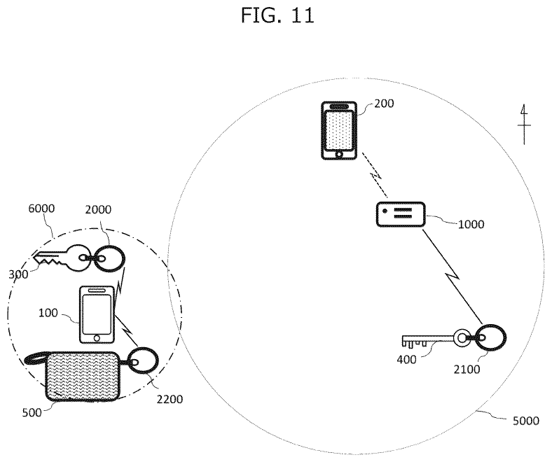

Next, an example of a different user taking the key 300 and the tag 2000 out of the BS management area 5000 is described with reference to FIG. 9 and FIG. 10. FIG. 9 is a diagram illustrating a state in which the tag 2000 has been taken out of the BS management area 5000 from the state shown in FIG. 1 by a user different from the user of the mobile terminal 100. FIG. 10 is a table showing an example of the device list when the state is transitioned from the state shown in FIG. 1 to the state shown in FIG. 9.

The tag 2000 is wirelessly connected to the BS 1000 using the short-range wireless communication interface 2010 in the state shown in FIG. 1, and when the user of the mobile terminal 100 takes the tag 2000 out of the BS management area 5000 (see FIG. 5A), the tag 2000 changes the wireless connection target from the BS 1000 to the mobile terminal 100. Then, when the user of the mobile terminal 100 brings the tag 2000 back inside the BS management area 5000, the wireless connection target of the tag 2000 is changed from the mobile terminal 100 to the BS 1000 to return to the state shown in FIG. 1 again, thus the device list turns back to FIG. 8A.

When the user of the mobile terminal 200, starting from this state, takes the key 300 and the tag 2000 out of the BS management area 5000 together with the mobile terminal 200 as shown in FIG. 9, the tag 2000 makes a wireless connection to the mobile terminal 200 using the short-range wireless communication interface 2010, and the status of the mobile terminal 200 and the tag 2000 in the device list is changed to the “taken-out” state as shown in FIG. 10. In addition, in the device list, the wireless connection target of the tag 2000 is updated to the mobile terminal 200, and the wireless connection target of the mobile terminal 200 is updated to the tag 2000.

According to the present embodiment, if a plurality of users bring back take out the tags 2000, 2100 and 2200 inside or out of the BS management area 5000, each time the tag 2000, 2100 or 2200 is brought back inside the BS management area 5000, the wireless connection target of the tag 2000, 2100 or 2200 using the short-range wireless communication interface 2010 is changed from the mobile terminal 100 or 200 of each user to the BS 1000, with the device list being updated each time. Therefore, since the tag 2000, 2100 or 2200 is passed on to another user via the BS 1000, the next user does not know who the previous user of the tag 2000, 2100 or 2200 is.

Furthermore, when the tag 2000, 2100 or 2200 is taken out of the BS management area 5000, the BS 1000 does not manage the absolute location of the tag 2000, 2100 or 2200, and the mobile terminal 100 or 200. This prevents invasion of privacy by keeping location information of the user who has taken the tag 2000, 2100 or 2200 out from being known to other users.

### <Second Embodiment>

FIG. 11 is a diagram illustrating a configuration of a sharing system for a loss-prevention tag according to a second embodiment. This is to specifically describe the second embodiment of a sharing method for the loss-prevention tag. In the second embodiment, when the tags 2000, 2100 and 2200, and the mobile terminals 100 and 200 are taken out of the BS management area 5000, the configuration includes a function that allows the mobile terminals 100 and 200 to measure relative locations of the tags 2000, 2100 and 2200 to determine whether they have been taken out at the same time or not. An example of taking out one mobile terminal 100 or 200 while making a short-range wireless communication connection to a plurality of tags 2000, 2100 and 2200 is also described.

FIG. 11 illustrates the state in which the mobile terminal 100 performs short-range wireless communication including UWB or Bluetooth (registered trademark), detects the tags 2000 and 2200 in a search area 6000, has them make a wireless connection to the mobile terminal 100 using the short-range wireless communication interfaces 1010 and 2010, and has normally been taken out of the BS management area 5000 together with the tags. The mobile terminal 100 itself can check the presence or absence of the tags 2000 and 2200 inside the search area 6000, which includes itself, thus it is also possible to monitor whether the mobile terminal 100 alone is taken out or not and to search for tags that are outside of the BS management area 5000.

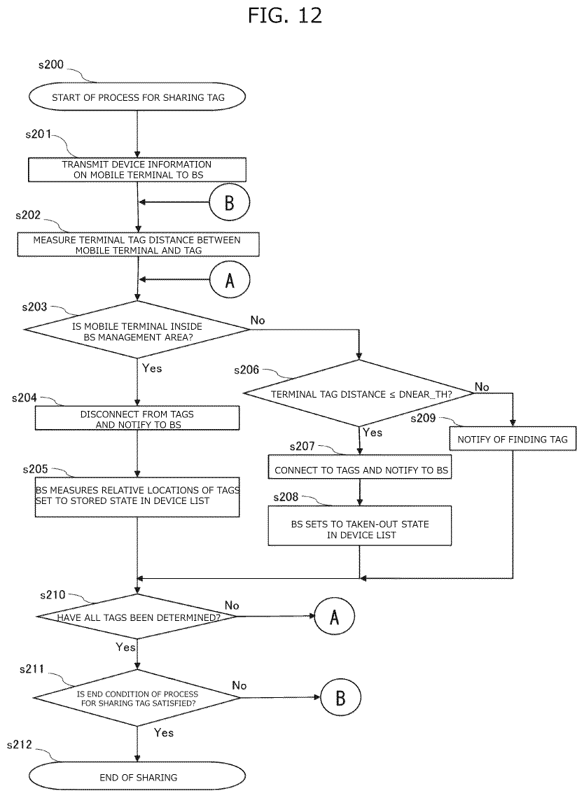

FIG. 12 is a flowchart illustrating a process for sharing the loss-prevention tag according to the second embodiment.

The mobile terminal 100 starts a tag sharing operation (s200). The mobile terminal 100 transmits its device information to the BS 1000 (s201), and the BS 1000 registers the device information of the mobile terminal 100 with the device list. It is assumed that the tags 2000, 2100 and 2200 have been registered with the BS 1000 as devices in advance.

For all of the tags 2000, 2100 and 2200, the mobile terminal 100 measures the distance between itself and each of the tags 2000, 2100 and 2200 (terminal tag distance) (s202).

If the mobile terminal 100 uses the radio wave intensity of Bluetooth (registered trademark) communication to measure the terminal tag distances to the tags 2000, 2100 and 2200, the BT interface serves as the distance sensor 109. If the UWB interface 115 is used to measure the terminal tag distances, the UWB interface serves as the distance sensor 109.

The mobile terminal 100 determines whether it is inside the BS management area 5000 or not based on relative location information between the BS 1000 and the mobile terminal 100 that is periodically transmitted from the BS 1000, information related to the coverage of the BS management area 5000 and other information (s203).

In s203, the mobile terminal 100 may measure the distance between itself and the BS 1000 (terminal BS distance) using its UWB interface 115. For example, if the terminal BS distance is less than a radius of the BS management area 5000, the mobile terminal 100 itself can be estimated to be inside the BS management area 5000. When the mobile terminal 100 itself returns to inside the BS management area 5000 from outside the BS management area 5000, it is assumed that the tags 2000 and 2200 that make wireless connection to the mobile terminal 100 using the short-range wireless communication interface 117 are also brought back to inside the BS management area 5000.

The mobile terminal 100, when determining that it is inside the BS management area 5000 (s203: Yes), disconnects the wireless connection to the tags 2000 and 2200 that have been brought back using the short-range wireless communication interface 117 and transmits a tag disconnection completion signal to the BS 1000 (s204).

The BS 1000, upon receiving the tag disconnection completion signal, makes a wireless connection to the tags 2000 and 2200 using the short-range wireless communication interface 1010, measures the relative locations of the tags 2000 and 2200 using the UWB interface 1011, updates location information in the device list and sets the status of the relevant tags 2000 and 2200 to “stored” (s205).

In contrast, the mobile terminal 100, when determining that it is outside the BS management area 5000 (s203: No), compares the terminal tag distances to the proximity determination distance threshold (Dnear_th) for all of the tags 2000, 2100 and 2200 (s206). If the terminal tag distance is equal to or less than the proximity determination distance threshold (s206: Yes), the mobile terminal 100 can estimate that itself and the tag 2000 or 2200 to be determined are in proximity. Then, the mobile terminal 100 transmits the tag disconnection request signal to the BS 1000 to disconnect the wireless connection between the BS 1000 and the tags 2000 and 2200 using the short-range wireless communication interface 117. The tag disconnection request signal includes the device information on the tags 2000 and 2200 to be disconnected, and the like. The BS 1000, upon receiving the tag disconnection request signal, disconnects the wireless connection to the tags 2000 and 2200 to be disconnected and transmits the tag disconnection completion signal to the mobile terminal 100.

The mobile terminal 100, upon receiving the tag disconnection completion signal, makes a wireless connection to the tags 2000 and 2200 using the short-range wireless communication interface 117 (s207).

The BS 1000 determines that the mobile terminal 100 and the tags 2000 and 2200 have normally been taken out, sets the status to “taken-out” and updates each of the wireless connection targets of the mobile terminal 100 to the tags 2000 and 2200 and the tags 2000 and 2200 to the mobile terminal 100 (s208).

The mobile terminal 100, when determining that it is outside the BS management area 5000 (s203: No) and no tag is recognized inside the proximity determination distance threshold (s206: No), determines that the mobile terminal 100 was taken out alone and transmits only the device information of the mobile terminal 100 to the BS 1000. The BS 1000 sets only the status of the mobile terminal 100 to “taken-out.” If it finds a tag whose terminal tag distance exceeds the proximity determination distance threshold (Dnear_th), it can determine that it has found a tag that is not being carried with itself.

Then, the device information of the tag that has exceeded the proximity determination distance threshold may be obtained, and the device information and a discovery notification may be transmitted to the BS 1000 (s209).

The BS 1000 may notify the mobile terminal 100 how to handle the tag for which the discovery notification was received. For example, the BS 1000 may not specifically instruct the mobile terminal 100 to retrieve the tag if the tag is in short-range wireless communication with another mobile terminal, in other words, if the tag is in “taken-out” state in the device list, but may prompt the user to instruct the mobile terminal 100 to retrieve the tag or to make an emergency call if the tag is in “abnormally taken-out” state. If the mobile terminal 100 has not finished notifying the BS 1000 that each of all the tags 2000, 2100 and 2200 is in any of the states of s205, s208 and s209 (s210: No), the flow returns to s203 and repeats the determination for the next tag. When the user goes out, he or she does not always take out only one tag. When a plurality of tags 2000 and 2200 are taken out, the mobile terminal 100 can make a wireless connection to the plurality of tags 2000 and 2200 inside the search area 6000 using the short-range wireless communication interface 117 by repeating the determination process described above.

When the mobile terminal 100 has finished notifying the BS 1000 for all of the tags 2000, 2100 and 2200 (s210: Yes) and continues a process for sharing the tags (s211: No), the flow returns to s202. If an end condition of the process for sharing the tags is satisfied (s211: Yes), the process ends (s212).

According to the second embodiment, since the mobile terminals 100 and 200 themselves include a search function for the tags 2000, 2100 and 2200, they can notify the BS 1000 when they find a tag that is not connected to themselves outside of the BS management area 5000. The BS 1000 can determine whether a tag needs to be retrieved or not based on the status of the relevant tag and notify the mobile terminals 100 and 200 as appropriate, making it easier, for example, to retrieve a missing tag when it is found by chance.

In the same manner as in the first embodiment, when the tags 2000, 2100 and 2200 are inside the BS management area 5000, the BS 1000 manages the relative locations of the tags 2000, 2100 and 2200, while when the tags 2000, 2100 and 2200 are outside the BS management area 5000, the mobile terminals 100 and 200 manage the locations of the tags 2000, 2100 and 2200 by making wireless connections to the tags 2000, 2100 and 2200 using the short-range wireless communication interface 117. Note, however, that the BS 1000 does not acquire the location information in the external coordinate system of the mobile terminals 100 and 200 that are outside the BS management area 5000 and only manages the fact that the tags 2000, 2100 and 2200 were taken out together with the mobile terminal 100 or 200, thus, when the tags 2000, 2100 and 2200 are shared, other users who share the tags will not know the location of the user who currently carries the tags 2000, 2100 and 2200 based on the locations of the tags 2000, 2100 and 2200.

Furthermore, when the user who currently carries the tags 2000, 2100 and 2200 brings them back to inside the BS management area 5000 and another user takes out the tags 2000, 2100 and 2200, the tags 2000, 2100 and 2200 will be connected to the BS 1000 once in the stored state before the other user takes out the tags 2000, 2100 and 2200. Therefore, the user who last carried the relevant tags 2000, 2100 and 2200 is not identified. These allow a plurality of o users to share the tags 2000, 2100 and 2200 without the destination and location information of each of the users being known to other users, thus protecting privacy and allowing the tags 2000, 2100 and 2200 to be shared at the same time.

The present invention is not limited to the embodiments described above and includes various modifications. For example, the coverage of the BS management area 5000 may be changed depending on the environment of use, such as at home or in the workplace.

An alert may also be issued when a tag is abnormally taken out. The alert may be notified to all of the mobile terminals 100 and 200, or only to the terminal that has been designated in advance.

The hardware used as the BS 1000 may be a PC or a smartphone. A smart speaker or a charging dock may also include BS functions.

The mobile terminals 100 and 200 are not limited to smartphones and may be a head-mounted display or a tablet device.

The tags 2000, 2100 and 2200 need not be limited to the “loss-prevention tags,” and devices such as wireless earphones and smartwatches that can be connected to the mobile terminal 100 or 200, or the BS 1000 via a wireless connection using the short-range wireless communication interface 2010 may be used as a device to be shared according to the present invention instead of the tags 2000, 2100 and 2200.

The method for measuring the relative locations is not limited to UWB. The same wireless communication means may be used for measuring the relative locations or for the wireless connections to the tags 2000, 2100 and 2200, or different means may be used.

Although a plurality of wireless communication means are shown in the block diagrams, not all of them are required.

As an additional function, a user name of the person who takes out a tag may be displayed when requested by the parent device. The parent device in this case may be the BS 1000, or the mobile terminal 100 or 200 that is connected to the BS 1000. This improves the usability of the sharing system for tags by displaying the user name without identifying the location of the user, since, for example, when sharing the tags in the workplace, it is sufficient to know which user carries the relevant tag, and there is no need to display the location of the user.

The configuration may be such that only items under management with the tags 2000, 2100 and 2200 attached can be taken out outside the BS management area 5000 as long as the parent device gives permission in advance. When allowing the tags to be taken out, for example, the tags are managed when they are taken out by setting a permitted take-out time or a scheduled time to return home. Furthermore, if the set time has passed, the mobile terminal 100 or 200, the BS 1000, or the tag 2000, 2100 or 2200 may trigger an alarm. This improves usability, for example, by allowing the tag 2000 attached to the key 300 to be excluded from the alert target for abnormal take-out when a child who does not possess a smartphone goes out with the key 300.

The mobile terminal 100 that is the wireless connection target using the short-range wireless communication interface 2010 of the tags 2000, 2100 and 2200 may be changed outside of the BS management area 5000. In this case, the mobile terminal 200, which is the target after the change, transmits a change permission request signal to the BS 1000 using the mobile communication interface 114. The BS 1000 transmits the tag disconnection request signal to the mobile terminal 100, which is the target before the change, and the tag connection request signal to the mobile terminal 200, which is to be the target after the change, to change the wireless connection targets of the tags 2000, 2100 and 2200 by operating each of the mobile terminals 100 and 200. When the change is completed, a change completion signal is transmitted to the BS 1000 using the mobile communication interface 114, and the BS 1000 changes the connection targets in the device list.

Although the embodiments of the present invention have been described above, it is to be understood that the configuration for realizing the technology according to the present invention is not limited to the embodiments described above, and various modifications are conceivable. For example, the embodiments described above have been described in detail to simply describe the present invention, and it is not necessarily limited to those that include all of the configurations described. In addition, part of the configuration of one embodiment can be replaced with one of the configurations of the other embodiments, and the configuration of one embodiment can be added to one of the configurations of the other embodiments. These are all within the scope of the present invention. The values, messages, or the like that appear in the text or figures are also only examples, and the use of different ones does not impair the advantageous effects of the present invention.

The program described in each of the processing examples may be a program that is independent of each other, or a plurality of programs may be included in a single application program. The order in which each of the processes is performed may be interchanged.

Some or all of the functions, and the like of the present invention described above may be realized in hardware, for example, by designing them as an integrated circuitry. They may also be realized in the form of software that is executed by a microprocessor unit, a CPU, or the like, which interprets operation programs to realize the respective functions, and the like. The coverage of software implementation is not limited, and a combination of hardware and software may also be used. Some or all of the functions may also be realized by a server. Note that the server is only required to be able to cooperate with other components and execute functions via communication, and examples include local servers, cloud servers, edge servers and network services, regardless of their form. Programs, tables, files and other information to realize each of the functions may be stored in a storage device such as a memory, a hard drive or a solid-state drive (SSD), a storage medium such as an IC card, an SD card or a DVD, or in a device on a communication network.

The control lines and information lines shown in the figures are those considered necessary for illustrative purposes and do not necessarily represent all control lines and information lines on a product. Almost all of the components may in fact be considered connected to each other.

The embodiments described above include the following forms.

### (Note 1)

A sharing system for a child device that makes a wireless communication connection to a parent device including: a child device; a parent device that makes a wireless connection to the child device using a short-range wireless communication interface; and a base station, in which the base station includes: a mobile communication interface that communicates with the parent device; a short-range wireless communication interface that performs short-range wireless communication with each of the parent device and the child device; a location measuring sensor that measures a child device location, which is a relative location of the child device to the base station, and a parent device location, which is a relative location of the parent device to the base station in a base station management area that consists of a real space including an existence location of the base station; a memory that stores a device list; and a first processor that updates the device list, in which the device list is registered with status information that indicates the parent device location, the child device location and a sharing state of the child device, in which the parent device includes a mobile communication interface and a parent device short-range wireless communication interface that performs short-range wireless communication with the child device, in which the child device includes a child device short-range wireless communication interface that performs short-range wireless communication with each of the base station and the parent device, in which the first processor, when determining that the child device is inside the base station management area based on the child device location, updates the status information of the child device in the device list to a stored state, makes a wireless connection to the child device using the short-range wireless communication interface of the base station, and when determining that the parent device has been taken out with the child device based on the child device location and the parent device location, disconnects the wireless connection of the child device to the base station, transmits a child device connection request signal that requests a wireless connection to the child device to the parent device, updates status of the child device in the device list to a taken-out state and updates a wireless connection target of the child device to the parent device, with the parent device making a wireless connection to the child device using the parent device short-range wireless communication interface in response to the child device connection request signal, in which the first processor, when determining that the child device has returned to inside the base station management area based on the child device location, transmits a child device disconnection request signal that requests disconnection of the wireless connection to the child device to the parent device, updates the status information of the child device in the device list to the stored state and updates the wireless connection target of the child device from the parent device to the base station, with the parent device disconnecting the wireless connection to the child device using the parent device short-range wireless communication interface in response to the child device disconnection request signal, and the base station making a wireless connection to the child device using the short-range wireless communication interface.

### (Note 2)

A sharing method for a child device that makes a wireless communication connection to a parent device including: a step in which a base station acquires a child device location, which is a relative location of the child device to the base station, and a parent device location, which is a relative location of the parent device that makes a wireless connection to the child device using a short-range wireless communication interface to the base station, in a base station management area that consists of a real space including an existence location of the base station; a step in which the base station, when determining whether the child device is inside the base station management area or not based on the child device location, updates status information of the child device in a device list stored in the base station to a stored state and makes a wireless connection of the base station to the child device; a step in which the base station, when determining that the parent device has been taken out with the child device based on the child device location and the parent device location, disconnects the wireless connection of the child device to the base station, transmits a child device connection request signal that requests a wireless connection to the child device to the parent device, updates status of the child device in the device list to a taken-out state and updates a wireless connection target of the child device to the parent device; a step in which the parent device makes a wireless connection to the child device in response to the child device connection request signal; a step in which the base station, when determining that the child device has returned to inside the base station management area based on the child device location, transmits a child device disconnection request signal that requests disconnection of the wireless connection to the child device to the parent device, updates the status information of the child device in the device list to the stored state and updates the wireless connection target of the child device from the parent device to the base station; a step in which the parent device disconnects the wireless connection to the child device in response to the child device disconnection request signal; and a step in which the base station makes a wireless connection to the child device.

### REFERENCE SIGNS LIST

1: sharing system
100: mobile terminal
101: control circuitry
102: main processor
103: ROM
104: RAM
105: flash memory
106: group of sensors
107: GPS receiver
108: geomagnetic sensor
109: distance sensor
110: acceleration sensor
111: gyro sensor
112: temperature sensor
113: communication processing section
114: mobile communication interface
116: wireless LAN interface
117: short-range wireless communication interface
118: video processing section
119: camera
120: image signal converter
121: display
122: audio processing section
123: microphone
124: codec
125: speaker
126: battery
127: data bus
128: RTC
200: mobile terminal
300: key
400: key
500: bag
1001: control circuitry
1002: main processor
1003: ROM
1004: RAM
1005: flash memory
1006: RTC
1007: communication processing section
1009: mobile communication interface
1010: short-range wireless communication interface
1011: UWB interface
1012: data bus
1013: speaker
1014: display
1015: power supply
1016: geomagnetic sensor
2000: tag
2001: control circuitry
2002: main processor
2003: ROM
2004: RAM
2005: flash memory
2007: communication processing section
2008: wireless LAN interface
2010: short-range wireless communication interface
2012: data bus
2013: speaker
2015: battery
2021: GPS interface
2022: LED
2100: tag
2200: tag
5000: BS management area
6000: search area

1. A sharing system for a child device that makes a wireless communication connection to a parent device comprising:
a child device;
a parent device that makes a wireless connection to the child device using a short-range wireless communication interface; and
a base station,
wherein the base station includes:
a mobile communication interface that communicates with the parent device;
a short-range wireless communication interface that performs short-range wireless communication with each of the parent device and the child device;
a location measuring sensor that measures a child device location, which is a relative location of the child device to the base station, and a parent device location, which is a relative location of the parent device to the base station in a base station management area that consists of a real space including an existence location of the base station;
a memory that stores a device list; and
a first processor that updates the device list,
wherein the device list is registered with status information that indicates the parent device location, the child device location and a sharing state of the child device,
wherein the parent device includes:
a mobile communication interface; and
a parent device short-range wireless communication interface that performs short-range wireless communication with the child device,
wherein the child device includes:
a child device short-range wireless communication interface that performs short-range wireless communication with each of the base station and the parent device,
wherein the first processor, when determining that the child device is inside the base station management area based on the child device location, updates the status information of the child device in the device list to a stored state, makes a wireless connection to the child device using the short-range wireless communication interface of the base station, and when determining that the parent device has been taken out with the child device based on the child device location and the parent device location, disconnects the wireless connection of the child device to the base station, transmits a child device connection request signal that requests a wireless connection to the child device to the parent device, updates status of the child device in the device list to a taken-out state and updates a wireless connection target of the child device to the parent device,
with the parent device making a wireless connection to the child device using the parent device short-range wireless communication interface in response to the child device connection request signal,
wherein the first processor, when determining that the child device has returned to inside the base station management area based on the child device location, transmits a child device disconnection request signal that requests disconnection of the wireless connection to the child device to the parent device, updates the status information of the child device in the device list to the stored state and updates the wireless connection target of the child device from the parent device to the base station,
with the parent device disconnecting the wireless connection to the child device using the parent device short-range wireless communication interface in response to the child device disconnection request signal, and the base station making a wireless connection to the child device using the short-range wireless communication interface.

2. The sharing system for a child device that makes a wireless communication connection to a parent device according to claim 1,
wherein the child device is at least one of a loss-prevention tag, a wireless earphone and a smartwatch.

3. The sharing system for a child device that makes a wireless communication connection to a parent device according to claim 1,
wherein the parent device is at least one of a mobile terminal and a head-mounted display.

4. The sharing system for a child device that makes a wireless communication connection to a parent device according to claim 1,
wherein the location measuring sensor is an ultra-wideband wireless communication interface.

5. The sharing system of a child device that makes a wireless communication connection to a parent device according to claim 1,
wherein the device list does not store an absolute location that indicates a unique location of each of the parent device and the child device in the real space.

6. The sharing system for a child device that makes a wireless communication connection to a parent device according to claim 1,
wherein the parent device further comprises: a distance sensor that measures a distance between the parent device and the child device; and
a second processor,
wherein the second processor, when a distance to the child device is equal to or less than a predetermined distance threshold outside the base station management area, makes a short-range wireless connection to the child device and notifies the base station of device information of the child device,
with the base station updating status of the child device in the device list to the taken-out state and updating a connection target of the child device to the parent device.

7. A sharing method for a child device that makes a wireless communication connection to a parent device comprising:
a step in which a base station acquires a child device location, which is a relative location of the child device to the base station, and a parent device location, which is a relative location of the parent device that makes a wireless connection to the child device using a short-range wireless communication interface to the base station, in a base station management area that consists of a real space including an existence location of the base station;
a step in which the base station, when determining whether the child device is inside the base station management area or not based on the child device location, updates status information of the child device in a device list stored in the base station to a stored state and makes a wireless connection of the base station to the child device;
a step in which the base station, when determining that the parent device has been taken out with the child device based on the child device location and the parent device location, disconnects the wireless connection of the child device to the base station, transmits a child device connection request signal that requests a wireless connection to the child device to the parent device, updates status of the child device in the device list to a taken-out state and updates a wireless connection target of the child device to the parent device;
a step in which the parent device makes a wireless connection to the child device in response to the child device connection request signal;
a step in which the base station, when determining that the child device has returned to inside the base station management area based on the child device location, transmits a child device disconnection request signal that requests disconnection of the wireless connection to the child device to the parent device, updates the status information of the child device in the device list to the stored state and updates the wireless connection target of the child device from the parent device to the base station;
a step in which the parent device disconnects the wireless connection to the child device in response to the child device disconnection request signal; and
a step in which the base station makes a wireless connection to the child device.
